(19) United States
(12) Patent Application Publication
(10) Pub. No.: US 2015/0317911 A1
(43) Pub. Date: Nov. 5, 2015

(54) MUSICAL PIECE EVALUATION DEVICE, MUSICAL PIECE EVALUATION METHOD, MUSICAL PIECE EVALUATION PROGRAM, AND INFORMATION STORAGE MEDIUM HAVING THE PROGRAM STORED THEREON

(71) Applicant: YAMAHA CORPORATION, Hamamatsu-shi, Shizuoka (JP)

(72) Inventor: Taro KAWABATA, Hamamatsu-shi (JP)

(21) Appl. No.: 14/650,080

(22) PCT Filed: May 19, 2014
(86) PCT No.: PCT/JP2014/063199

§ 371 Date: Jun. 5, 2015

(30) Foreign Application Priority Data
May 23, 2013 (JP) 2013-108806

(51) Int. Cl. G09B 15/02

(52) U.S. Cl. CPC G09B 15/02

(57) ABSTRACT

A degree of difficulty of a musical piece is comprehensively evaluated also in consideration of a viewpoint of expressions and dynamics of the musical piece. A segment evaluator evaluates a degree of segment difficulty. The degree of segment difficulty indicates the degree of difficulty in performance of a segment (for example, a predetermined number of measures) serving as a part of the musical piece. The segment evaluator divides the musical piece into a plurality of segments, and evaluates the degree of segment difficulty for each of the plurality of segments. The degree of segment difficulty is evaluated in accordance with a predetermined algorithm. A musical piece evaluator evaluates a degree of musical piece difficulty. The degree of musical piece difficulty indicates a degree of difficulty in the performance of the entire musical piece. The musical piece evaluator evaluates the degree of musical piece difficulty of the musical piece based on a change of the degree of segment difficulty within the musical piece.

### TECHNICAL FIELD

The present invention relates to a technology for evaluating a degree of difficulty in performing a musical piece.

### BACKGROUND ART

A degree of difficulty in performing a musical piece differs depending on which musical piece is performed. For example, when information indicating the degree of difficulty of the musical piece is presented in a system for practicing a musical instrument, the information serves as an index that is important for a performer to select the musical piece. Various technologies for evaluating the degree of difficulty in the performance are known (for example, Patent Literatures 1 to 4).

In Patent Literatures 1 and 2, there are disclosed technologies for evaluating the degree of difficulty in the performance based on the number of sounds per unit time. In Patent Literature 3, there is disclosed a technology for evaluating the degree of difficulty based on an average sound duration of each note. In Patent Literature 4, there is disclosed a technology for evaluating the degree of difficulty based on fingering information.

### CITATION LIST

### Patent Literature

[Patent Literature 1] JP 2011-191431 A

[Patent Literature 2] JP 2002-323891 A

[Patent Literature 3] JP 2005-107333 A

[Patent Literature 4] JP 2008-151966 A

### SUMMARY OF INVENTION

### Technical Problem

Each of Patent Literatures 1 to 4 employs an evaluation method for evaluating a degree of difficulty of a musical piece as high when the musical piece has many technically difficult parts. According to such an evaluation method, a performer who has not mastered a high-level technique feels that the evaluated degree of difficulty matches actual difficulty of performance. However, in light of a more musical viewpoint so as to exert expressions and dynamics of a musical piece, there is a problem in that the degree of difficulty of a musical piece cannot be determined only based on a technical aspect as to whether or not the musical piece can be played simply in accordance with the notes.

In contrast, the present invention provides a technology for comprehensively evaluating the degree of difficulty also in consideration of a viewpoint of the expressions and the dynamics of the musical piece.

### Solution to Problem

According to one embodiment of the present invention, there is provided a musical piece evaluation device includes a segment evaluator configured to evaluate, for a musical piece divided into a plurality of segments, a degree of segment difficulty indicating a degree of difficulty of performance within each of the plurality of segments, in accordance with a predetermined algorithm. The musical piece evaluation device also includes a musical piece evaluator configured to evaluate a degree of musical piece difficulty indicating a degree of difficulty in the performance of the entire musical piece based on a change of the degree of segment difficulty within the musical piece.

The musical piece evaluator may evaluate the degree of musical piece difficulty as high, as the change of the degree of segment difficulty within the musical piece becomes larger.

The musical piece evaluator may evaluate the degree of musical piece difficulty as high, as an absolute value of a change of the degree of segment difficulty between two consecutive segments becomes larger.

### Advantageous Effects of Invention

According to one or more embodiments of the present invention, it is possible to comprehensively evaluate the degree of difficulty also in consideration of a viewpoint of the expressions and the dynamics of the musical piece.

### BRIEF DESCRIPTION OF DRAWINGS

FIG. 1 is a diagram illustrating a hardware configuration of a musical piece evaluation device 1.

FIG. 2 is a diagram illustrating a functional configuration of the musical piece evaluation device 1 according to an embodiment of the present invention.

FIG. 3 is a flowchart illustrating an operation of the musical piece evaluation device 1.

FIG. 4 is a diagram exemplifying a relationship between a degree of segment difficulty and a degree of musical piece difficulty.

### DESCRIPTION OF EMBODIMENT

### 1. Configuration

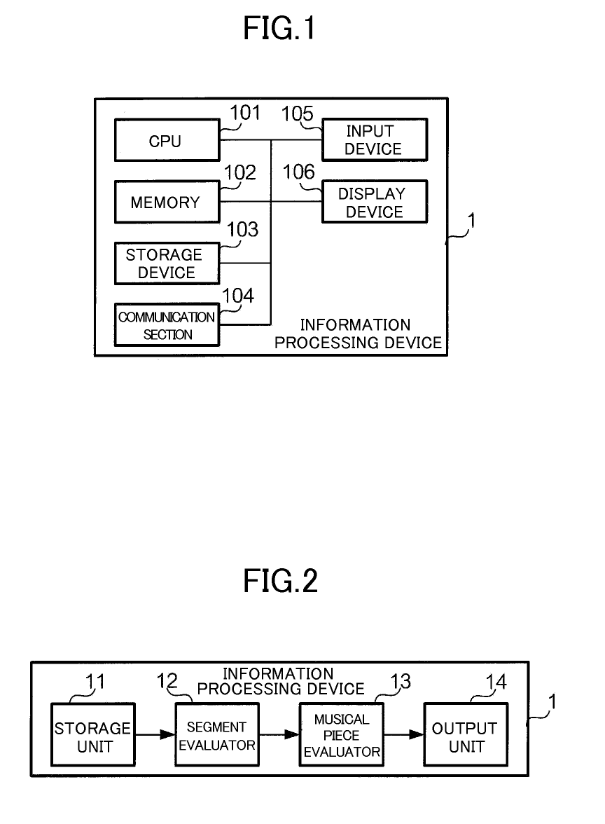

FIG. 1 is a diagram illustrating a hardware configuration of a musical piece evaluation device 1 according to an embodiment of the present invention. The musical piece evaluation device 1 is, for example, a personal computer. The musical piece evaluation device 1 includes a CPU 101, a memory 102, a storage device 103, a communication section 104, an input device 105, and a display device 106. The CPU 101 is a control device for controlling each hardware component of the musical piece evaluation device 1. The memory 102 is a storage device that functions as a work area used when the CPU 101 executes a program. The storage device 103 includes a storage device for storing data and a program, for example, a hard disk drive (HDD) or a flash memory. For example, the program may be provided by being downloaded through a network or may be provided by each different kind of computer-readable information recording medium such as a CD-ROM or a DVD-ROM. In this example, the storage device 103 stores a practice support program for supporting a practice of a musical instrument. The practice support program includes an evaluation program for evaluating a degree of difficulty of the musical piece from a music file, as a subprogram (module). The communication section 104 is a device for communicating to/from another device through the network (for example, Internet), and includes, for example, a network card. The input device 105 is a device for inputting a user's instruction to the CPU 101, and includes, for example, at least one of a keyboard or a pointing device (for example, mouse or touch screen). The display device 106 is a device for displaying information (at least one of a character or an image), and includes, for example, a liquid crystal display.

FIG. 2 is a diagram illustrating a functional configuration of the musical piece evaluation device 1 according to the embodiment. The musical piece evaluation device 1 includes a storage unit 11, a segment evaluator 12, a musical piece evaluator 13, and an output unit 14. The storage unit 11 stores at least one music file. The music file is a file including information indicating performance (content) of a musical piece. In more detail, the music file includes time information and information indicating an event (for example, on/off of sound). Specifically, the music file is, for example, a standard musical instrument digital interface (MIDI) file (SMF). For example, the music file is acquired from a server on the network, and is stored in the storage unit 11. The segment evaluator 12 evaluates a degree of segment difficulty. The degree of segment difficulty indicates the degree of difficulty when performing a segment (for example, a predetermined number of measures) that defines a part of a musical piece. The segment evaluator 12 divides the musical piece into a plurality of segments, and evaluates (calculates) the degree of segment difficulty for each of the plurality of segments. The degree of segment difficulty is evaluated in accordance with a predetermined algorithm. The musical piece evaluator 13 evaluates a degree of musical piece difficulty. The degree of musical piece difficulty indicates the degree of difficulty when performing the entire musical piece. The musical piece evaluator 13 evaluates (calculates) the degree of musical piece difficulty of the musical piece based on a change of the degree of segment difficulty within the musical piece. The output unit 14 outputs information indicating the degree of musical piece difficulty evaluated by the musical piece evaluator 13.

In this example, the CPU 101 executes the practice support program, to thereby implement the functions illustrated in FIG. 1. The storage device 103 is an example of the storage unit 11. The CPU 101 for executing the practice support program is an example of the segment evaluator 12 and the musical piece evaluator 13. The display device 106 is an example of the output unit 14.

### 2. Operation

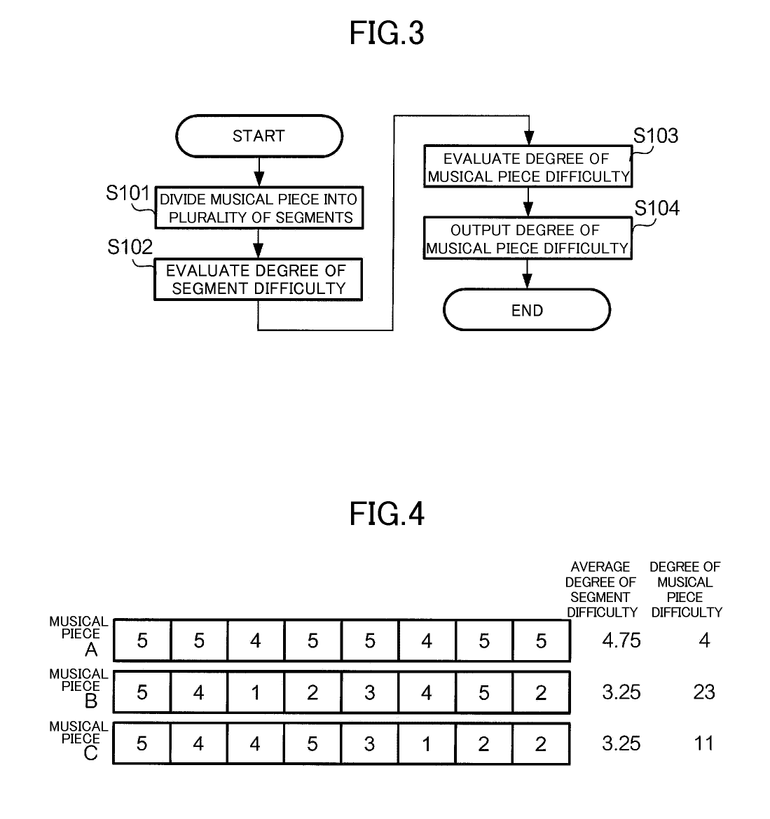

FIG. 3 is a flowchart illustrating an operation of the musical piece evaluation device 1. The flow of FIG. 3 is started in response to, for example, a trigger based on a timing when the evaluation program is called.

In Step S101, a segment dividing unit divides a musical piece (hereinafter referred to as “target musical piece”) indicated by a music file serving as a processing target into a plurality of segments. A method of dividing a musical piece into the plurality of segments differs depending on the algorithm for evaluating the degree of segment difficulty. For example, a method of dividing a musical piece every predetermined period on a musical score (for example, predetermined number of measures) is used. Alternatively, the musical piece may be divided at regular intervals temporally. Note that, the segment dividing unit may be set as one function of the segment evaluator 12, or may be provided separately from the segment evaluator 12.

In Step S102, the segment evaluator 12 evaluates the degree of segment difficulty of each segment. The degree of segment difficulty is evaluated by using a known algorithm. Specifically, the degree of segment difficulty is evaluated by using an algorithm that evaluates the degree of difficulty as higher as the number of sounds per segment becomes larger. In another example, an algorithm that evaluates the degree of difficulty as higher as an average sound duration per segment becomes shorter may be used. In further another example, an algorithm that evaluates the degree of difficulty as higher as the cost of fingering becomes higher may be used. In the case, for example, the cost of fingering is evaluated as higher as a distance between pitches of two consecutive sounds becomes farther, and as higher as an interval between the two consecutive sounds (that is, sound duration of the first sound) becomes shorter. Specific processing is performed as follows. The segment evaluator 12 identifies one segment from among the plurality of segments forming the target musical piece as a segment to be processed (hereinafter referred to as “target segment”) in order one by one. The segment evaluator 12 evaluates the degree of segment difficulty for the target segment. The segment evaluator 12 stores the degree of segment difficulty calculated for the target segment in the storage unit 11. The segment evaluator 12 repeatedly executes the processing until the degrees of segment difficulty have been evaluated for all the segments included in the target musical piece.

In Step S103, the musical piece evaluator 13 calculates the degree of musical piece difficulty. In this example, the musical piece evaluator 13 evaluates the degree of musical piece difficulty as high, as the change of the degree of segment difficulty within the target musical piece becomes larger. In more detail, the musical piece evaluator 13 evaluates the degree of musical piece difficulty as high, as an absolute value of a change of the degree of segment difficulty between two consecutive segments becomes larger. Specifically, the musical piece evaluator 13 calculates the degree of musical piece difficulty in accordance with the following Expression (1).

$$\begin{matrix}( Expression 1 ) & \\ Dh = {\sum }_{i = 1}^{n} {\{ Dp ( i ) - Dp ( i - 1 ) \}}^{2} & ( 1 )\end{matrix}$$

In the expression, Dh represents the degree of musical piece difficulty, Dp (i) represents the degree of segment difficulty of a segment i, and n represents the number of segments within the target musical piece.

In Step S104, the output unit 14 outputs the calculated degree of musical piece difficulty, and displays the degree of musical piece difficulty on the display device 106. For example, the output unit 14 displays a list including a file name of the musical piece and the degree of musical piece difficulty on the display device 106.

FIG. 4 is a diagram exemplifying a relationship between the degree of segment difficulty and the degree of musical piece difficulty. In this example, the relationship between the degree of segment difficulty and the degree of musical piece difficulty is illustrated for three musical pieces illustrated as musical pieces A, B, and C. The musical pieces A, B, and C are each divided into eight segments. The degree of segment difficulty is indicated by five levels of from “1” to “5”. The lowest degree of difficulty is “1”, and the highest degree of difficulty is “5”. From the viewpoint of an average value of the degrees of segment difficulty throughout the musical piece, the musical pieces are ranked as (musical piece A)>(musical piece B)=(musical piece C). That is, according to the related-art evaluation method, the musical piece A is the most difficult, while the musical piece B and the musical piece C have the same degree of difficulty.

On the other hand, according to the evaluation method according to one or more embodiments of the present invention, the musical piece A has a high average value of the degree of segment difficulty while having little variations, and, therefore, the musical piece A is evaluated as having a low degree of musical piece difficulty. The musical piece B has a lower average value of the degree of segment difficulty than that of the musical piece A while having rich variations, and, therefore, the musical piece B is evaluated as having a high degree of musical piece difficulty. The musical piece C has the same average value of the degree of segment difficulty as that of the musical piece B. However, the musical piece C has the first half exhibiting higher degrees of difficulty and the second half exhibiting lower degrees of difficulty, and the musical piece C has a smaller change of the degree of segment difficulty than that of the musical piece B. Thus, the musical piece C is evaluated as having a lower degree of musical piece difficulty than that of the musical piece B.

As explained above, according to this embodiment, it is possible not only to evaluate the degree of technical difficulty simply based on how difficult the fingering is, but also to evaluate the degree of difficulty of the musical piece in consideration of musical expressions such as the expressions and dynamics of a musical piece. For example, when the degree of musical piece difficulty is presented in a system for practicing a musical instrument, it is possible to provide information used as a reference when the user selects the musical piece to be practiced.

### 3. Modification Example

The present invention is not limited to the above-mentioned embodiment, and may be modified variously. Some modified examples are described below. Two or more of the following modified examples may be used in a combination thereof.

A specific calculation method for the degree of musical piece difficulty is not limited to the method using Expression (1). For example, the degree of musical piece difficulty may be obtained by taking an average value or an integrated value of the degree of segment difficulty into consideration. More specifically, for example, the degree of musical piece difficulty may be calculated by multiplying the value calculated by Expression (1) by the average value or the integrated value of the degree of segment difficulty. In another example, the degree of musical piece difficulty may be obtained by eliminating an influence of a duration of the musical piece. More specifically, for example, the degree of musical piece difficulty may be calculated by dividing the value calculated by Expression (1) by a number n of segments. In further another example, the degree of musical piece difficulty may be calculated by multiplying each of the terms of Expression (1) by a coefficient corresponding to a tempo or a dynamic mark. Further, the method of reflecting the absolute value of the change of the degree of segment difficulty between the two consecutive segments on the degree of musical piece difficulty is not limited to the method of squaring the difference in the degree of segment difficulty.

The musical piece evaluation device 1 is not limited to the personal computer. The musical piece evaluation device 1 may be an electronic device other than the personal computer such as an electronic musical instrument, a tablet terminal, or a smartphone. Note that, when the present invention is applied to the electronic musical instrument, the electronic musical instrument needs to include components corresponding to the storage device 103, the input device 105, and the display device 106.

A part or all of the functions described above with reference to FIG. 2 may be provided to the server on the network. That is, an information processing system including a terminal device operated by the user and a server device on the network may include the functions illustrated in FIG. 2.

Further, the functions illustrated in FIG. 2 may be implemented by a program other than the practice support program for a musical piece. For example, the functions illustrated in FIG. 2 may be implemented as a program module for selecting a musical piece to be performed in a performance program or a playback program for a musical piece.

The hardware configuration of the musical piece evaluation device 1 is not limited to one described above with reference to FIG. 1. The musical piece evaluation device 1 may include any kind of hardware configuration that implement the functions described above with reference to FIG. 2. For example, the musical piece evaluation device 1 may be a device used as a stand-alone device instead of being connected to the network.

A correspondence relationship between the functional configuration and the hardware configuration of the musical piece evaluation device 1 is not limited to one described above in the embodiment. For example, the output unit 14 is not limited to one that visually outputs the degree of musical piece difficulty by the display device 106. For example, the output unit 14 may electronically output the degree of musical piece difficulty as data. Alternatively, the output unit 14 may output the degree of musical piece difficulty in a form of sound or voice. For example, a sound having a higher pitch may be output as the degree of difficulty becomes higher.

The music file is not limited to SMF. A music file having any format that indicates the performance of the musical piece may be used.

Further, to divide the target musical piece into a plurality of segments, in addition to the above-mentioned method, for example, each segment may be determined based on a position of a rest in a musical score or a staff of the musical score, or the user may designate each segment.

1. A musical piece evaluation device, comprising:
a segment evaluator configured to evaluate, for a musical piece divided into a plurality of segments, a degree of segment difficulty indicating a degree of difficulty of performance within each of the plurality of segments, in accordance with a predetermined algorithm; and
a musical piece evaluator configured to evaluate a degree of musical piece difficulty indicating a degree of difficulty in the performance of the entire musical piece based on a change of the degree of segment difficulty within the musical piece.

2. The musical piece evaluation device according to claim 1, wherein the musical piece evaluator evaluates the degree of musical piece difficulty as high, as the change of the degree of segment difficulty within the musical piece becomes larger.

3. The musical piece evaluation device according to claim 2, wherein the musical piece evaluator evaluates the degree of musical piece difficulty as high, as an absolute value of a change of the degree of segment difficulty between two consecutive segments becomes larger.

4. The musical piece evaluation device according to claim 3, wherein the musical piece evaluator calculates the degree of musical piece difficulty by obtaining a sum of values respectively based on the absolute value of the change of the degree of segment difficulty between the two consecutive segments.

5. The musical piece evaluation device according to claim 4, wherein the musical piece evaluator calculates the degree of musical piece difficulty by dividing the sum by a number of the plurality of segments.

6. The musical piece evaluation device according to claim 4, wherein the musical piece evaluator calculates the degree of musical piece difficulty by multiplying the sum by an average value or an integrated value of the degree of segment difficulty.

7. A musical piece evaluation method, comprising:
evaluating, for a musical piece divided into a plurality of segments, a degree of segment difficulty indicating a degree of difficulty of performance within each of the plurality of segments, in accordance with a predetermined algorithm; and
evaluating a degree of musical piece difficulty indicating a degree of difficulty in the performance of the entire musical piece based on a change of the degree of segment difficulty within the musical piece.

8. A musical piece evaluation program, comprising the instructions of:
evaluating, for a musical piece divided into a plurality of segments, a degree of segment difficulty indicating a degree of difficulty of performance within each of the plurality of segments, in accordance with a predetermined algorithm; and
evaluating a degree of musical piece difficulty indicating a degree of difficulty in the performance of the entire musical piece based on a change of the degree of segment difficulty within the musical piece.

9. A non-transitory computer-readable recording medium having stored thereon a musical piece evaluation program, the musical piece evaluation program comprising the instructions of:
evaluating, for a musical piece divided into a plurality of segments, a degree of segment difficulty indicating a degree of difficulty of performance within each of the plurality of segments, in accordance with a predetermined algorithm; and
evaluating a degree of musical piece difficulty indicating a degree of difficulty in the performance of the entire musical piece based on a change of the degree of segment difficulty within the musical piece.
